(19) United States
(12) Patent Application Publication
(10) Pub. No.: US 2026/0053178 A1
(43) Pub. Date: Feb. 26, 2026

(54) Nutritional composition with galactose for infants or young children

(71) Applicant: N.V. Nutricia, Zoetermeer (NL)

(72) Inventors: Maryam Rakhshandehroo, Utrecht (NL); Irini Schoeman-Gliziakis, Utrecht (NL); Evert Matthijs van Schothorst, Wageningen (NL)

(73) Assignee: N.V. Nutricia, Zoetermeer (NL)

(21) Appl. No.: 19/375,304

(22) Filed: Oct. 31, 2025

Related U.S. Application Data
(63) Continuation of application No. PCT/EP2024/062441, filed on May 6, 2024.

(30) Foreign Application Priority Data
May 5, 2023 (EP) 23171858.6

(51) Int. Cl. A23L 33/00; A23L 33/115; A23L 33/125; A23L 33/175; A23L 33/18; A23L 33/185

(52) U.S. Cl. CPC A23L 33/40; A23L 33/115; A23L 33/125; A23L 33/175; A23L 33/18; A23L 33/185

(57) ABSTRACT

The present invention relates to a nutritional composition for infants and young children comprising a digestible carbohydrate component, wherein the digestible carbohydrate component comprises a mixture of free galactose and at least one digestible carbohydrate selected from the group consisting of maltodextrin and glucose syrup, and with reduced or no lactose and glucose. The invention also relates to the use of the nutritional composition according to the invention for improving body composition or body composition development.

### FIELD OF THE INVENTION

The invention is in the field of nutritional compositions for infants and young children, in particular for infants or toddlers that suffer from cow's milk protein allergy or lactose intolerance. The invention further relates to nutritional compositions for use in improving body composition, or body composition development, in an infant or a young child.

### BACKGROUND

Human milk is the preferred source of early life nutrition. It has been shown to support healthy infant growth and development and to provide protection against several immunological conditions in early life, including various infectious and allergic diseases.

Although breast milk is the preferred nutrition for infants, it is sometimes not desired or not chosen and in that case infant formulas are commercially available that supply nutrition to the infant. Typically such infant formulas contain intact proteins from cow's milk, vegetable oils and as digestible carbohydrate lactose, as the main digestible carbohydrate in human milk is lactose.

However, such formulas may not be suitable for infants that suffer from cow's milk protein allergy or lactose intolerance. In early life, cow's milk protein allergy is the most dominant food allergy with currently 2-5% of infants suffering from cow's milk allergy. Therefore, for infants suffering from allergy to cow's milk protein, infant formulas are on the market comprising extensively hydrolysed proteins that contain hardly any allergenic protein or peptides. In severe cases formulas based on free amino acids as nitrogen source are present that contain no allergenic protein or peptides.

Additionally such formulas have often a reduced amount of lactose, or can even be lactose free. The preferred carbohydrate for infant formulas is lactose but lactose added to infant and young child formulas is derived from cow's milk and this may not be desired in formulas for infants or young children that are severely allergic to cow's milk protein. Formulas should also contain no or low lactose if the infant or young child is lactose intolerant. Lactose intolerance can be due to injury to the small intestine, for example caused by infection, celiac disease, inflammatory bowel disease, or other diseases, may occur in premature babies, or may be due to congenital lactose intolerance. In lactose free or low lactose products it is common to use maltodextrin or glucose corn syrups. Such formulas with a higher amount of added corn syrup or added maltodextrin have a disadvantage that they have a higher glycemic index when compared to formulas containing lactose, which may result in disadvantageous metabolic health effects later in life.

Another approach to reduce the lactose content is to hydrolyze the lactose with lactase into glucose and galactose. However, there is still the disadvantage that the lactose is derived from cow's milk and typically a substantial amount of lactose remains unhydrolyzed. Therefore the lactose hydrolysis solution which results in production of glucose and galactose in a one to one ratio is not desired for infant formulas and young child formulas.

WO 2007/004883 discloses a composition wherein the carbohydrate fraction comprises 5-30 wt. % of monosaccharides selected from galactose, ribose and mannose and 5-65 wt. % of carbohydrates capable of providing sustained release glucose. The use is for controlling glucose levels and metabolic disorders.

WO 2019/169424 discloses lactose-free milk products. Carbohydrate level is reduced which results in increased stability and improved osmolality.

WO 2006/130204 discloses an infant formula with a low-lactose and partially hydrolyzed protein. The lactose is derived from the protein sources such as caseinate and the remainder of the carbohydrate is preferably corn syrups.

WO 2016/018533 discloses a nutritional composition having enhanced sweetness perception, which includes a protein or protein equivalent source; a fat or lipid source; and a carbohydrate, wherein the protein or protein equivalent source has endogenous lactose which is at least 50% hydrolyzed and/or the composition includes lactose which is at least 80% hydrolyzed.

Bouwman et al. (J. Nutr. 2019, 149, 1140-1148) found that compared to glucose a 1:1 mixture of galactose and glucose, mimicking the composition of lactose, protected against adiposity and improved metabolic health later in life after exposure to a Western style diet in female mice. However the composition contains a high level of free glucose. Effects were only shown in female mice.

Therefore there is a need to develop nutritional compositions, in particular formulas for infants or young children, that have low lactose or are lactose free, that do not have too high a level of monomeric glucose and that have a low glycemic index that is more comparable to lactose.

### SUMMARY OF THE INVENTION

Using a mice model the inventors surprisingly found that a diet with a source of digestible carbohydrates that comprised a mixture of maltodextrin and free galactose resulted in positive effects on the body composition or body composition development in early life, when compared to a diet comprising maltodextrin but not galactose. The relative fat mass in the group consuming the diet with galactose and maltodextrin was significantly lower when compared to the relative fat mass of the group that had consumed maltodextrin but no galactose. The relative lean body mass was lower in the maltodextrin group compared to the group consuming galactose and maltodextrin; this was due to the fat mass increasing to a relatively higher extent than the lean body mass in the maltodextrin group. The observed effects on body composition development were similar in male and female mice. Additionally the respiratory exchange rate (RER) was lower in the mice consuming the maltodextrin and galactose diet when compared to the mice consuming the maltodextrin diet without galactose. The results with mice consuming the diet comprising galactose and maltodextrin were comparable to the results obtained with mice consuming a diet comprising free glucose and galactose, representing lactose. However, the presence of a large amount of free glucose has additional disadvantages relating to e.g. regulatory requirements, taste imprinting and powder product technological properties.

These results are indicative for the beneficial effects in infants or young children of a nutritional composition for infants and young children comprising a protein component, a lipid component, a digestible carbohydrate component, and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

### DETAILED DESCRIPTION OF THE INVENTION

The verb “to comprise” and its conjugations, as used in this description and in the claims, are used in their non-limiting sense to mean that items following the word are included, but items not specifically mentioned are not excluded.

Reference to an element by the indefinite article “a” or “an” does not exclude the possibility that more than one of the elements is present, unless the context clearly requires that there is one and only one of the elements. The indefinite article “a” or “an” thus usually means “at least one”.

The nutritional composition according to the invention comprises a protein component, a lipid component and a digestible carbohydrate component. For sake of clarity, the term “protein component” refers to the total amount of protein that is present in the nutritional composition. Similarly the term “digestible carbohydrate” refers to the total amount of digestible carbohydrate that is present in the nutritional composition and the term lipid component” refers to the total amount of lipid that is present. In other words, the nutritional composition comprises one protein component, one digestible carbohydrate component and one lipid component.

In a first aspect, the invention relates to a nutritional composition for infants and young children, the composition comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component, and
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

In a second aspect, the invention relates to the nutritional composition according to the invention, for use in providing nutrition to an infant or young child. This aspect of the invention may also be worded as a method for providing nutrition to an infant or a young child, wherein a composition according to the invention is administered to the infant or young child.

In a third aspect the invention relates to the nutritional composition according to the invention, for use in improving body composition or body composition development in an infant or a young child, wherein the improvement is preferably a decreased relative amount of fat mass and/or increased relative amount of lean body mass. This third aspect of the invention may also be worded as a method for improving body composition or body composition development in an infant or a young child, wherein the improvement is preferably a decreased relative amount of fat mass and/or increased relative amount of lean body mass, wherein the method comprises a step of administering the nutritional composition according to the invention to the infant or young child.

In a fourth aspect, the invention relates to a nutritional composition according to the invention, for use in decreasing the respiratory exchange rate and/or increasing fat oxidation in an infant or young child. This fourth aspect of the invention may also be worded as a method for decreasing the respiratory exchange rate and/or increasing fat oxidation in an infant or young child, the method comprising the administration of a composition according to the invention to the infant or young child.

As defined above, the nutritional composition according to the invention comprises a protein component, a lipid component, a digestible carbohydrate component and optionally a non-digestible oligosaccharide. The digestible carbohydrate component, protein component, lipid component and optional non-digestible oligosaccharide are described in more detail below.

### Digestible Carbohydrate Component

The nutritional composition of the present invention comprises a digestible carbohydrate component, wherein the digestible carbohydrate component comprises a mixture of free galactose and at least one digestible carbohydrate selected from the group consisting of maltodextrin and glucose syrup. A nutritional composition comprising a digestible carbohydrate component comprising such mixture was found to have an improved effect on the body composition and/or body composition development. As described above, said mixture is a mixture of free galactose and at least one digestible carbohydrate selected from the group consisting of maltodextrin and glucose syrup. In other words, said mixture is a mixture of free galactose and maltodextrin; or a mixture of free galactose and glucose syrup; or a mixture of free galactose and maltodextrin and glucose syrup. The digestible carbohydrate component thus comprises a mixture of galactose in the free form and at least one of maltodextrin and glucose syrup. Additional digestible carbohydrates may be present in the digestible carbohydrate component. In a preferred embodiment, the nutritional composition comprises a digestible carbohydrate component comprising a mixture of free galactose and maltodextrin.

Galactose, a digestible carbohydrate, is an aldohexose and a C-4 epimer of glucose, Galactose may also be referred to as D-Galactose, D-(+)-Galactose, (+)-Galactose, galactopyranose, α-D-Galactopyranose, (+)-Galactose, (2S,3R,4S,5R,6R)-6-(Hydroxymethyl)tetrahydro-2H-pyran-2,3,4,5-tetraol, (2S,3R,4S,5R,6R)-6-(hydroxymethyl)oxane-2,3,4,5-tetrol. For the purpose of the present invention galactose is present in the form of free monomers, i.e. monosaccharides (as opposed to galactose that is present in disaccharides, oligo- or polysaccharides). The term “free galactose” or “galactose in the free form” thus refers to galactose in the form of free monomers.

Galactose has a low glycemic index (GI) of 25. The main pathway of galactose metabolism is the Leloir pathway in the liver. Galactose is a monosaccharide sugar that is about as sweet as glucose, and about 65% as sweet as sucrose. Galactose is commercially available. It can for example be isolated from hydrolysed lactose. However, this is not preferred for (severely) allergic subjects, as lactose is typically derived from milk, typically cow's milk, and (cow's) milk derived products are to be avoided in nutritional compositions for subjects who are (severely) allergic to (cow's) milk. Galactose can also be synthesized chemically. As an example, galactose may be derived from plants by enzymatic hydrolysis of plant-derived galactan. In the nutritional composition according to the present invention, such plant-derived galactose is preferred as galactose source. Plant fibers rich in galactan are for example galactomannan from acacia gum. Such plant-based or non-animal based source is particularly preferred in a nutritional composition that is completely plant-based and suitable for vegans. Such plant-based compositions are also more sustainable. Plant-based galactose is for example commercially available from Zhejiang Yixin Pharmaceutical Co Plant. Nutriscience Innovations USA also supplies galactose that is not milk derived. In a preferred embodiment of the nutritional composition according to the invention the galactose is not from animal origin; preferably the galactose is from plant or microbial origin.

The digestible carbohydrate component of the nutritional composition comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component, and
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

The total amount of monosaccharides in the digestible carbohydrate component should not be too high. In the nutritional composition according to the invention, the sum of mono- and disaccharides, excluding lactose, is preferably at most 3.0 g per 100 kcal of the composition, preferably at most 2.5 g per 100 kcal of the composition. More preferably the amount of mono- and disaccharides, excluding lactose, is at most 1.25 g per 100 kcal of the nutritional composition according to the invention. When the nutritional composition is in the form of a liquid, e.g. as a ready-to-use liquid, the total amount of mono- and disaccharides, excluding lactose, is preferably at most 1.70 g per 100 ml, more preferably at most 0.85 g per 100 ml. When the nutritional composition is in the form of a powder, the total amount of mono- and disaccharides, excluding lactose, is preferably at most 12.14 g per 100 g of the powdered composition, more preferably at most 6.07 g per 100 g.

It is not desired to have the complete digestible carbohydrate component existing essentially of galactose. This would result in an amount of free monomeric sugars that is too high, which is not desired but also not allowed for infant and follow on formulas. For the same reasons a mixture of free galactose and free glucose is not desired. Additionally, a digestible carbohydrate component that would essentially consist of free galactose or of a mixture of free galactose and free glucose would have a much sweeter taste as compared to lactose or as compared to a mixture of free galactose and maltodextrin and/or glucose syrup with a dextrose equivalent (DE) in the range of 3 to 32. A sweeter taste than lactose may disadvantageously imprint the infant or young child to develop a preference for sweet foods, which may result in unhealthy dietary habits later in life with an increased risk of developing obesity and metabolic disease. Using a mixture of free galactose and maltodextrin and/or glucose syrup with a DE in the range of 3 to 32, instead of a mixture of free glucose and galactose, has the additional benefit that galactose is the only monosaccharide present. Consequently, galactose may be present at higher levels without compromising the regulations that limit the amount of total monosaccharides. Monomeric carbohydrates also will increase the osmolarity of a nutritional composition as compared to lactose or a mixture of free monomers and maltodextrin and this may not be desired if the nutritional composition has small peptides or free amino acids as protein source instead of intact proteins. In addition, because free glucose is a humectant and hydroscopic, and galactose, lactose and maltodextrin or glucose syrup are less so, for a powder product like infant formulas, a powder low in free glucose has superior properties.

As described above, the nutritional composition comprises a digestible carbohydrate component that comprises a mixture of free galactose and at least one digestible carbohydrate selected from the group consisting of maltodextrin and glucose syrup, wherein said maltodextrin and glucose syrup have a dextrose equivalent (DE) in the range of 3 to 32. Preferably, the maltodextrin and glucose syrup have a DE in the range of 10 to 25 and more preferably in the range of 17 to 22.

Maltodextrin and glycose syrup are glucose polymers, which are produced from vegetable starch such as e.g. corn starch or wheat starch by partial hydrolysis. Maltodextrin and glycose syrup are moderately sweet or almost flavorless. The glycemic index (GI) is comparable to glucose. Maltodextrin consists of D-glucose units connected in chains of variable length. The glucose units are primarily linked with α(1→4) glycosidic bonds. Maltodextrin is typically composed of a mixture of chains that vary from 3 to 17 glucose units. For the purpose of the present invention the degree of polymerization (DP) of maltodextrin is 3 or higher. Preferably the DP of maltodextrin is in the range of 3 to 25, more preferably in the range of 3 to 20. Consequently, any glucose and maltose that may be present in the source of maltodextrin are not considered to be maltodextrin, since the DP of glucose and maltose is lower than 3. Maltodextrins are classified by their DE (dextrose equivalent) and have a DE in the range of 3 to 20. The higher the DE value, the shorter the glucose chains and the higher the sweetness. When the DE is higher than 20, the composition is referred to as glucose syrup. Corn syrup is an example of a glucose syrup. Glucose syrup with a high DE is less desired because of the increased sweet taste. In addition, starch, or a maltodextrin with a very low DE, is not preferred as this will thicken the infant formula. Hence the maltodextrin and glucose syrup in the mixture of free galactose and at least one of maltodextrin and glucose syrup have a DE in the range of 3 to 32, preferably in the range of 10 to 25, more preferably in the range of 15 to 25, even more preferably in the range of 17 to 22.

In one embodiment of the nutritional composition according to the invention the at least one digestible carbohydrate is glucose syrup, and the digestible carbohydrate component thus comprises a mixture of free galactose and glucose syrup, wherein the glucose syrup has a DE in the range of >20-32, preferably from >20-25, more preferably in the range of >20-22.

In a preferred embodiment of the nutritional composition according to the invention the at least one digestible carbohydrate is maltodextrin, and the digestible carbohydrate component comprises a mixture of free galactose and maltodextrin, wherein the maltodextrin has a DE in the range of 3 to 20, preferably in the range of 10 to 20, more preferably in the range of 17 to 20 and most preferably in the range of 19 to 20.

As the carbohydrate in human milk is lactose, which is a disaccharide composed of glucose and galactose monomers, preferably the content of other carbohydrates such as fructose, sucrose, palatinose, isomaltulose in the digestible carbohydrate component is very low.

As described above, in the nutritional composition according to the invention the mixture of free galactose and at least one digestible carbohydrate selected from the group consisting of maltodextrin and glucose syrup is present in an amount of at least 50 wt % based on the total weight of the digestible carbohydrate component. In otherwords, the amount of free galactose together with maltodextrin and/or glucose syrup with the DE as defined above is at least 50 wt % based on the total weight of the digestible carbohydrate component, preferably at least 75 wt %, more preferably at least 85 wt % and even more preferably at least 95 wt %, all based on the total weight of the digestible carbohydrate component. The amount of free galactose is in the range of 10 to 60 wt % based on total weight of the digestible carbohydrate component, preferably in the range of 10 to 50 wt % and more preferably in the range of 10 to 25 wt %, all based on total weight of the digestible carbohydrate component. The amount of maltodextrin and/or glucose syrup is in the range of 40 to 90 wt % based on total weight of the digestible carbohydrate component, preferably in the range of 50 to 90 wt % and more preferably in the range of 75 to 90 wt %, all based on total weight of the digestible carbohydrate component. The w/w ratio of galactose to maltodextrin and/or glucose syrup is preferably of 1:9 to 1.5:1, more preferably from 1:5 to 1.5:1, even more preferably from 1:3 to 1:1.

The amount of free glucose is at most 10 wt % based on total weight of the digestible carbohydrate component. In addition, the amount of free glucose is lower than the amount of free galactose, wherein the amount of free glucose and the amount of free galactose are both based on the total weight of the digestible carbohydrate component. Preferably, the amount of free glucose is at most 80 wt % based on the total weight of free galactose. As an example, if the amount of free galactose in the nutritional composition would be 11 wt % based on total weight of the digestible carbohydrate component, then the amount of free glucose is at most 80 wt % of this amount of free galactose, i.e. 8.8 wt % based on total weight of the digestible carbohydrate component. However, since the amount of free glucose is at most 10 wt % based on total weight of the digestible carbohydrate component, if the amount of free galactose in the nutritional composition would for example be 15 wt % based on total weight of the digestible carbohydrate component, then the amount of free glucose is at most 10 wt % based on total weight of the digestible carbohydrate component.

Lactose is preferably present in the nutritional composition in an amount of less than 45 wt %, based on total weight of the digestible carbohydrate component, more preferably less than 20 wt %, more preferably less than 10 wt %, even more preferably less than 1 wt % and most preferably less than 0.1 wt %, all based on total weight of the digestible carbohydrate component. In another preferred embodiment the composition comprises less than 0.1 wt. % lactose, preferably less than 0.05 wt %, based on dry weight of the nutritional composition. Preferably the lactose content in the product is lower than 10 mg/100 kcal.

The nutritional composition preferably comprises, based on calories, 3 to 20 g of the mixture of galactose and at least one digestible carbohydrate selected from maltodextrin and glucose syrup, preferably maltodextrin, per 100 kcal, more preferably 5 g to 15 g per 100 kcal. The nutritional composition preferably comprises, based on calories, 0.3 to 12 g galactose per 100 kcal, more preferably 0.5 g to 9 g per 100 kcal, even more preferably 2 to 7.5 g. The nutritional composition preferably comprises, based on calories, 1.2 to 18 g of the at least one carbohydrate selected from maltodextrin and glucose syrup, preferably maltodextrin, per 100 kcal, more preferably 2 g to 13.5 g per 100 kcal, even more preferably 2.5 to 9 g.

When in liquid form, e.g. as a ready-to-use liquid, the nutritional composition preferably comprises 2 g to 15 g of the mixture of galactose and at least one digestible carbohydrate selected from maltodextrin and glucose syrup, preferably maltodextrin, per 100 ml, more preferably 3.5 g to 10 g per 100 ml. When in liquid form, e.g. as a ready-to-use liquid, the nutritional composition preferably comprises 0.2 g to 9 g galactose per 100 ml, more preferably 0.35 g to 6 g per 100 ml, even more preferably 1.4 to 5 g per 100 ml. When in liquid form, e.g. as a ready-to-use liquid, the nutritional composition preferably comprises 0.8 g to 13.5 g of the at least one digestible carbohydrate selected from maltodextrin and glucose syrup, preferably maltodextrin, per 100 ml, more preferably 1.4 g to 9 g per 100 ml, even more preferably 1.75 g to 6 g.

Based on dry weight the nutritional composition preferably comprises 15 wt % to 85 wt %, more preferably 20 wt % to 65 wt % of the mixture of galactose and at least one digestible carbohydrate selected from maltodextrin and glucose syrup, preferably maltodextrin. Worded alternatively, when the nutritional composition is in powder form, the mixture of galactose and at least one carbohydrate selected from maltodextrin and glucose syrup, preferably maltodextrin, is preferably present in an amount of 15 g to 85 g/100 g dry weight, more preferably 20 g to 65 g/100 g dry weight. Based on dry weight the nutritional composition preferably comprises 1.5 wt % to 51 wt %, more preferably 2 wt % to 39 wt % galactose, even more preferably 8 to 32.5 wt %. Worded alternatively, when the nutritional composition is in powder form, the galactose is preferably present in an amount of 1.5 g to 51 g/100 g dry weight, more preferably 2 g to 39 g/100 g dry weight, even more preferably 8 to 32.5 wt %. Based on dry weight the nutritional composition preferably comprises 6 wt % to 76.5 wt %, more preferably 8 wt % to 58.5 wt %, even more preferably 10 to 39 wt % of one carbohydrate selected from maltodextrin and glucose syrup, preferably maltodextrin. Worded alternatively, when the nutritional composition is in powder form, the at least one digestible carbohydrate selected from maltodextrin and glucose syrup, preferably maltodextrin, are preferably present in an amount of 6 g to 76.5 g/100 g dry weight, more preferably 8 g to 58.5 g/100 g dry weight, even more preferably 10 to 39 g/100 g dry weight.

### Nutritional Composition

The nutritional composition according to the invention is not native cow's milk or native milk from another mammal. The present nutritional composition comprises a digestible carbohydrate component, a protein component and a lipid component, wherein the lipid component preferably provides 30 to 60%, preferably 35 to 55% of the total calories, the protein component preferably provides 5 to 15%, more preferably 6 to 12%, even more preferably 7 to 9% of the total calories and the digestible carbohydrate component preferably provides 25 to 75%, more preferably 40 to 60% of the total calories. The composition may optionally further comprise a non-digestible oligosaccharide, i.e. one or more non-digestible oligosaccharides. Non-digestible oligosaccharides have a caloric density of 2 kcal/g and, if present, preferably make up 0.4 to 7% of total calories. The lipid component of the nutritional composition preferably comprises 3 g to 7 g per 100 kcal, preferably 4 g to 6 g per 100 kcal, more preferably 4.5 g to 5.5 g per 100 kcal. The nutritional composition preferably comprises 1.25 g to 4 g of the protein component per 100 kcal, more preferably 1.5 g to 3.0 g protein component per 100 kcal, more preferably 1.8 g to 2.2 g protein component per 100 kcal. The nutritional composition preferably comprises 6 g to 20 g of the digestible carbohydrate component per 100 kcal, more preferably 10 g to 15 g of the digestible carbohydrate component per 100 kcal.

Preferably the nutritional composition has an energy density of 45 to 75 kcal/100 ml, more preferably 60 to 70 kcal/100 ml, even more preferably 65 to 70 kcal/100 ml, when in a ready-to-use form. This density ensures an optimal balance between hydration and caloric intake.

The nutritional composition is preferably in the form of a solid product, preferably in the form of a powder. Suitably, the nutritional composition is in a powdered form, which can be reconstituted with water, to form a ready-to-use liquid. Alternatively, the nutritional composition may be a ready-to-use liquid. The nutritional composition may also be in the form of a liquid concentrate that should be diluted with water in order to obtain a ready-to-use liquid.

The nutritional composition comprises a digestible carbohydrate component. Based on calories the nutritional composition preferably comprises 6 g to 20 g of the digestible carbohydrate component per 100 kcal, more preferably 10 g to 15 g per 100 kcal. When in liquid form, e.g. as a ready-to-use liquid, the nutritional composition preferably comprises 4 g to 15 g digestible carbohydrate component per 100 ml, more preferably 7 g to 10 g per 100 ml. Based on dry weight the nutritional composition preferably comprises 30 wt % to 85 wt %, more preferably 40 wt % to 65 wt % digestible carbohydrates. Worded alternatively, when the nutritional composition is in powder form, the digestible carbohydrates are preferably present in an amount of 40 g to 85 g/100 g dry weight, more preferably 40 g to 65 g/100 g dry weight.

### Proteins

The nutritional composition comprises a protein component. The protein component comprises one or more sources of protein. Sources of protein include for example cow's milk protein and plant protein such as soy protein, rice protein and pea protein. The terms “protein” and “protein component” encompass intact proteins, peptides, free amino acids and hydrolysed proteins. Hydrolysed proteins may be partially hydrolysed or extensively hydrolysed. The protein component may comprise intact proteins, hydrolysed proteins, peptides and/or free amino acids. The amount of protein component in the nutritional composition is determined by the sum of intact protein, hydrolysed protein, peptides and free amino acids. Preferably the nutritional composition comprises 1.25 g to 4 g protein component per 100 kcal, more preferably 1.5 g to 3.0 g protein component per 100 kcal, even more preferably 1.8 to 2.2 g per 100 kcal. A low protein component concentration advantageously is closer to human milk as human milk comprises a lower amount of protein based on total calories compared to cow's milk. Based on a ready-to-use liquid product the nutritional composition preferably comprises 0.8 to 2.5 g per 100 ml, more preferably 1.0 g to 2.0 g/100 ml, even more preferably 1.2 to 1.5 g per 100 ml of the protein component. Based on dry weight the nutritional composition preferably comprises 6 to 18 wt %, more preferably 7 to 15 wt %, even more preferably 8 to 11 wt % protein component. Worded alternatively, when the nutritional composition is in a powder form, the protein component is preferably present in an amount of 6 g to 18 g/100 g dry weight, more preferably 7 to 15 g, even more preferably 8 to 11 g/100 g dry weight of the composition. The source of the protein component is preferably selected in such a way that the minimum requirements for essential amino acid content are met and satisfactory growth is ensured. Hence protein sources based on cows' milk proteins such as whey, casein and combinations thereof and proteins based on soy, rice or pea, and combinations thereof, are preferred. In case whey proteins are used, the protein source is preferably based on acid whey or sweet whey, modified sweet whey, whey protein isolate, or combinations thereof.

It is preferred that the protein component is non-allergenic or hypoallergenic. Preferably the protein component is in the form of intact plant protein, hydrolyzed plant protein, hydrolyzed cow's milk protein and/or free amino acids. Such protein components are suitable for infants or young children that are at risk of or have an allergy for cow's milk protein. More preferably the protein components is selected from plant protein, hydrolyzed plant protein and/or free amino acids. Such protein components are suitable for infants and young children that have a severe allergy for cow's milk protein. Plant protein, intact or hydrolyzed, has the advantage that they are suitable for vegans. Suitable plant proteins are rice protein, soy protein or pea protein, and combinations thereof.

Thus, in a preferred embodiment of the nutritional composition according to the invention, the protein component is at least one selected from the group consisting of free amino acids, hydrolyzed protein and plant protein, preferably at least one selected from the group consisting of free amino acids and plant protein. The plant protein may be intact or hydrolyzed.

### Lipids

The nutritional composition of the present invention comprises a lipid component. The lipid component is preferably present in an amount of 3 g to 7 g per 100 kcal, more preferably in an amount of 4 g to 6 g lipid per 100 kcal and most preferably in an amount of 4.5 g to 5.5 g lipid per 100 kcal. When in liquid form, e.g. as a ready-to-use liquid, the nutritional composition preferably comprises 2.2 g to 4.5 g lipid per 100 ml, more preferably 2.5 to 4.0 g, even more preferably 3.0 to 3.75 g per 100 ml. Based on dry weight the nutritional composition preferably comprises 16 to 32 wt %, more preferably 18 to 30 wt %, even more preferably 20 to 28 wt % lipid. Worded alternatively, when the nutritional composition is in powder form, the lipids are preferably present in an amount of 16 g to 32 g/100 g dry weight, more preferably 18 to 30 g, even more preferably 20 to 28 g/100 g dry weight of the composition.

The lipid preferably comprises vegetable lipid. The presence of vegetable lipid advantageously enables an optimal fatty acid profile high in polyunsaturated fatty acids, such as essential linolenic acid and alpha-linolenic acid, and is more reminiscent to human milk fat. Lipid from non-human mammalian milk alone, e.g. cow's milk, does not provide an optimal fatty acid profile. Typically, the amount of essential fatty acids is too low in non-human mammalian milk. Preferably the nutritional composition comprises at least one, more preferably at least two vegetable lipid sources selected from the group consisting of linseed oil (flaxseed oil), rape seed oil (such as colza oil, low erucic acid rape seed oil and canola oil), sunflower oil, high oleic sunflower oil, safflower oil, high oleic safflower oil, olive oil, coconut oil, soy oil, palm oil and palm kernel oil. Additionally egg oil and/or fish oil and/or microbial oils such as oil from fungi and algae may be present. Such oils are suitable sources of long-chain polyunsaturated fatty acids such as docosahexaenoic acid (DHA), arachidonic acid (ARA) and/or eicosapentaenoic acid (EPA). Preferably the nutritional composition comprises n3 LC-PUFA, such as EPA and/or DHA, more preferably DHA. Preferably the nutritional composition comprises at least 0.05 wt %, preferably at least 0.1 wt %, more preferably at least 0.2 wt %, DHA based on total fatty acids. Preferably the nutritional composition comprises not more than 2.0 wt %, preferably not more than 1.0 wt % DHA based on total fatty acids. The nutritional composition preferably comprises ARA. Preferably the nutritional composition comprises at least 0.05 wt %, preferably at least 0.1 wt %, more preferably at least 0.2 wt % ARA based on total fatty acids.

### Non-Digestible Oligosaccharides

Optionally the nutritional composition of the invention additionally comprises one or more non-digestible oligosaccharides [NDO]. Advantageously and most preferred, the non-digestible oligosaccharide is water-soluble (according to the method disclosed in L. Prosky et al, J. Assoc. Anal. Chem 71: 1017-1023, 1988) and is preferably an oligosaccharide with a degree of polymerisation (DP) of 2 to 200. The average DP of the non-digestible oligosaccharide is preferably below 200, more preferably below 100, even more preferably below 60, most preferably below 40. The non-digestible oligosaccharide is preferably a prebiotic. The non-digestible oligosaccharide is not digested in the intestine by the action of digestive enzymes present in the human upper digestive tract (small intestine and stomach). The non-digestible oligosaccharide is fermented by the human intestinal microbiota. For example, glucose, fructose, galactose, sucrose, lactose, maltose, maltodextrins and glucose syrup are considered digestible carbohydrates. Although the sources of non-digestible oligosaccharide may comprise digestible carbohydrates such as glucose, fructose, fucose, galactose, rhamnose, xylose, glucuronic acid, lactose etc., these are not part of the non-digestible oligosaccharides, but included with the digestible carbohydrates instead.

The non-digestible oligosaccharide is preferably selected from the group consisting of fructooligosaccharide, galactooligosaccharide, human milk oligosaccharides and combinations thereof, more preferably from the group consisting of fructooligosaccharides, galactooligosaccharides and combinations thereof.

One suitable type of non-digestible oligosaccharide is a short-chain (sc) oligosaccharide which has an average degree of polymerisation of less than 10, preferably at most 8, preferably in the range of 2-7. The short-chain oligosaccharide preferably comprises galacto-oligosaccharides and/or fructo-oligosaccharides (i.e. scGOS and/or scFOS). In one embodiment, the nutritional composition comprises galacto-oligosaccharides, preferably beta-galacto-oligosaccharides. The galacto-oligosaccharides preferably have an average degree of polymerisation in the range of 2-8, preferably 3-7, i.e. are short-chain oligosaccharides in the context of the invention. Beta-galactooligosaccharides are for example available under the trade name Vivinal® GOS (FrieslandCampina Domo Ingredients, Netherlands), Bimuno (Clasado), Cup-oligo (Nissin Sugar) and Oligomate55 (Yakult). The nutritional composition preferably comprises short-chain fructo-oligosaccharides and/or short-chain galacto-oligosaccharides, preferably at least short-chain fructo-oligosaccharides. Fructooligosaccharides may be inulin hydrolysate products having an average DP within the aforementioned (sub-)ranges; such FOS products are for instance commercially available as Raftilose P95 (Orafti) or with Cosucra.

Another suitable type of oligosaccharide is long-chain fructo-oligosaccharides (IcFOS) which has an average degree of polymerisation above 10, typically in the range of 10-100, preferably 15-50, most preferably above 20. A particular type of long-chain fructo-oligosaccharides is inulin, such as Raftilin HP.

Most preferred are fructo-oligosaccharides, because galacto-oligosaccharides are typically formed from lactose and contain residual lactose, which is milk derived, and which may not be desired in nutritional compositions for subjects with severe allergy to cow's milk protein or severe lactose intolerance.

The nutritional composition may contain a mixture of two or more types of non-digestible oligosaccharides, most preferably a mixture of two non-digestible oligosaccharides. In case the NDO comprises or consists of a mixture of two distinct oligosaccharides, one oligosaccharide may be short-chain (sc) as defined above and one oligosaccharide may be long-chain (lc) as defined above. Most preferably, short-chain oligosaccharides and long-chain oligosaccharides are present in a weight ratio short-chain to long-chain in the range of 1:99-99:1, more preferably 1:1-99:1, more preferably 4:1-97:3, even more preferably 5:1-95:5, even more preferably 7:1-95:5, even more preferably 8:1-10:1, most preferably about 9:1. When the non-digestible oligosaccharide is a mixture, the averages of the respective parameters are used for defining the present invention.

In one embodiment, the nutritional composition comprises at least two of fructo-oligosaccharides. Suitable mixtures include mixtures of long-chain fructo-oligosaccharides with short-chain fructo-oligosaccharides or with short-chain galacto-oligosaccharides, most preferably long-chain fructo-oligosaccharides with short-chain fructo-oligosaccharides.

The nutritional composition preferably comprises 0.05 to 20 wt % of said non-digestible oligosaccharides, more preferably 0.5 to 15 wt %, even more preferably 1 to 10 wt %, most preferably 2 to 10 wt %, based on dry weight of the nutritional composition. When in liquid form, the nutritional composition preferably comprises 0.01 to 2.5 wt % non-digestible oligosaccharide, more preferably 0.05 to 1.5 wt %, even more preferably 0.25 to 1.5 wt %, most preferably 0.5-1.25 wt %, based on 100 ml.

Preferably further ingredients are present in the nutritional composition like vitamins, minerals, trace elements, nucleotides and other micronutrients as known in the art.

The nutritional composition according to the invention is preferably in the form an infant formula, a follow-on formula or a young child formula. This means that the composition that is to be administered is not human milk. Infant formula or follow-on formula or young child formula means that it concerns a composition that is artificially made or in other words that it is a synthetic composition. In the context of the present invention, young child formula can also be named growing-up milk. The present nutritional composition preferably is intended for, or is used for, providing nutrition to an infant or young child.

Infant formulas are intended for infants from birth to about 4 to 6 months of age and are intended as a substitute for human milk. Typically, infant formulae are suitable to be used as sole source of nutrition. Such infant formulae are also known as starter formula. In the context of the present invention this is referred to as a nutritional composition, or infant formula, for the first 6 months of life.

Follow-on formulas are intended for infants starting with 4 to 6 months of age to 12 months of age and are intended to be supplementary feedings for infants that start weaning on other foods. In the context of the present invention this is referred to as a nutritional composition, or follow-on formula, for the age of 6 to 12 months.

Young child formula refers to nutritional compositions, artificially made, intended for children of 12 months to up to 48 months of age, in other words for children of 1 to 3 years of age which are intended to be supplementary feedings. In the context of the present invention this is referred to as a nutritional composition, or young child formula, for the age of 12 months up to 48 months, in other words for the age of 1 to 3 years.

Infant formulae and follow-on formulae are subject to strict regulations, for example for the EU regulations no. 609/2013 and no. 2016/127 and Codex Alimentarius for Infant Formula, CODEX STAN 72-1981. Young child formulas preferably follow the directive for follow-on formula.

Preferably the nutritional composition, more preferably the infant formula, follow on formula or young child formula, is free of animal products, so is free of animal proteins such as cow's milk proteins or other cow's milk derived products such as milk fat or lactose. In other words, in a preferred embodiment of the present invention, the nutritional composition according to the invention does not contain animal-derived ingredients.

### Application

The nutritional composition according to the invention is preferably used for providing nutrition to an infant or young child. An infant is a human child under the age of 12 months. A young child is a human child aged from 1 to 3 years old (12 months up to 48 months), also called a toddler, In a second aspect, the invention thus relates to the nutritional composition according to the invention, for use in providing nutrition to an infant or young child, preferably an infant of 6 to 12 months of age or a young child aged from 1 to 3 years old. Preferably the nutritional composition of the present invention is provided to a human subject during the first 4 years of life, more preferably during 6 up to 48 months of age.

Preferably the nutritional composition of the present invention is for use in providing nutrition to an infant or young child that is lactose intolerant. In that case the amount of lactose should be low, below 1 wt % based on total digestible carbohydrates, more preferably below 0.1 wt %. In this embodiment it is preferred that the amount of lactose is below 0.1 wt %, preferably below 0.05 wt %, based on dry weight of the nutritional composition. Most preferably the amount of lactose is at most about 10 mg per 100 kcal, and/or at most about 6.7 mg per 100 ml or lower, and/or at most about 48 mg per 100 g powder, based on dry weight. Preferably the lactose content in the product is lower than 10 mg/100 kcal in this embodiment.

The invention thus also relates to a nutritional composition comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component, and the amount of free glucose is lower than the amount of free galactose, both based on total weight of the digestible carbohydrate component, preferably the amount of free glucose is at most 80 wt % based on the total weight of free galactose,
and the amount of lactose in the nutritional composition is below 0.1 wt %, preferably below 0.05 wt %, based on dry weight of the nutritional composition,
   for use in providing nutrition to an infant or young child, wherein the infant or young child is lactose intolerant.

In this embodiment of the invention it is preferred that the galactose in the nutritional composition is not from animal origin; preferably the galactose is from plant or microbial origin.

Preferably the nutritional composition of the present invention is for use in providing nutrition to an infant or young child that is at risk of developing allergy, in particular cow's milk protein allergy. In the context of the present invention, the term “an infant or young child at risk of developing an allergy” refers to an infant or a young child born from parents of whom one or both suffers from an allergy, or an infant or young child who has one or more siblings suffering from an allergy, in particular cow's milk protein allergy. These infants and young children have a higher risk of becoming allergic to certain foods, e.g. to dietary proteins, in particular cow's milk proteins.

Preferably the nutritional composition of the present invention is for use in providing nutrition to an infant or young child that suffers from cow's milk allergy, preferably cow's milk protein allergy. In that case the protein component is preferably hydrolysed milk protein, plant protein, and/or free amino acids, more preferably plant protein and/or free amino acids. Plant protein may be intact plant protein and/or hydrolysed plant protein, more preferably hydrolysed plant protein.

The invention thus also relates to a nutritional composition comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component, and the amount of free glucose is lower than the amount of free galactose, both based on total weight of the digestible carbohydrate component, preferably the amount of free glucose is at most 80 wt % based on the total weight of free galactose,
and wherein the protein component is at least one selected from the group consisting of hydrolysed milk protein, plant protein, free amino acids,
   for use in providing nutrition to an infant or young child, wherein the infant or young child is at risk of developing an allergy and/or suffers from an allergy, preferably a cow's milk allergy.

In this embodiment the protein fraction is thus composed of hydrolysed milk protein, plant protein and/or free amino acids. Preferably the protein fraction is composed of at least one of plant protein and free amino acids. Plant protein may be intact plant protein, hydrolysed plant protein or combinations thereof, preferably the plant protein is hydrolysed plant protein. In this embodiment it is also preferred that the galactose in the nutritional composition is not from animal origin, more preferably the galactose is from plant or microbial origin. It is further preferred that the nutritional composition does not contain animal-derived ingredients.

As described above, in some jurisdictions the provision of food to an infant or young child is considered non-therapeutic. Hence in these jurisdictions the invention relates to a (non-therapeutic) method for providing nutrition to an infant or a young child, wherein a nutritional composition according to the invention is administered to the infant or young child.

The invention also relates to a (non-therapeutic) method for providing nutrition to an infant or a young child, wherein the infant or young child is lactose intolerant, and wherein a nutritional composition is administered to said infant or young child, the nutritional composition comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component, and the amount of free glucose is lower than the amount of free galactose, both based on total weight of the digestible carbohydrate component, preferably the amount of free glucose is at most 80 wt % based on the total weight of free galactose,
and the amount of lactose in the nutritional composition is below 0.1 wt %, preferably below 0.05 wt %, based on dry weight of the nutritional composition.

In this embodiment of the invention it is preferred that the galactose in the nutritional composition is not from animal origin; preferably the galactose is from plant or microbial origin.

The invention further relates to a (non-therapeutic) method for providing nutrition to an infant or a young child, wherein the infant or young child is at risk of developing an allergy and/or suffers from an allergy, preferably cow's milk protein allergy, and wherein a nutritional composition is administered to said infant or young child, the nutritional composition comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component, and the amount of free glucose is lower than the amount of free galactose, both based on total weight of the digestible carbohydrate component, preferably the amount of free glucose is at most 80 wt % based on the total weight of free galactose,
and wherein the protein component is at least one selected from the group consisting of hydrolysed milk protein, plant protein, free amino acids.

In this embodiment the protein fraction is thus composed of hydrolysed milk protein, plant protein and/or free amino acids. Preferably the protein fraction is composed of at least one of plant protein and free amino acids. Plant protein may be intact plant protein, hydrolysed plant protein or combinations thereof, preferably the plant protein is hydrolysed plant protein. In this embodiment it is also preferred that the galactose in the nutritional composition is not from animal origin, more preferably the galactose is from plant or microbial origin. It is further preferred that the nutritional composition does not contain animal-derived ingredients.

In another aspect, the invention relates to the use of a mixture of free galactose and at least one digestible carbohydrate selected from the group consisting of maltodextrin and glucose syrup, wherein said maltodextrin and glucose syrup have a dextrose equivalent (DE) of 3 to 32, preferably 10 to 25, more preferably 17 to 22, for the manufacturing of a nutritional composition for use in providing nutrition to an infant or young child, wherein the nutritional composition comprises a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component, and
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

In a specific embodiment of this aspect of the invention, the infant or young child is lactose intolerant and the amount of lactose in the nutritional composition is below 0.1 wt %, preferably below 0.05 wt %, based on dry weight of the nutritional composition. In this embodiment it is preferred that the galactose in the nutritional composition is not from animal origin, more preferably the galactose is from plant or microbial origin.

In another specific embodiment of this aspect of the invention, the infant or young child is at risk of developing an allergy and/or suffers from an allergy, preferably cow's milk protein allergy and the protein fraction in the nutritional composition is composed of hydrolysed milk protein, plant protein and/or free amino acids. Preferably the protein fraction is composed of at least one of plant protein and free amino acids. Plant protein may be intact plant protein, hydrolysed plant protein or combinations thereof, preferably the plant protein is hydrolysed plant protein. In this embodiment it is also preferred that the galactose in the nutritional composition is not from animal origin, more preferably the galactose is from plant or microbial origin. It is further preferred that the nutritional composition does not contain animal-derived ingredients. In a particular preferred embodiment of this embodiment the nutritional composition does not contain animal-derived ingredients.

Using a mice model the inventors surprisingly found that a diet with a source of digestible carbohydrates that contained a mixture of maltodextrin and free galactose resulted in positive effects on the body composition or body composition development in early life, when compared to a diet containing maltodextrin but not galactose. The relative fat mass in the group consuming the diet with galactose and maltodextrin was significantly lower when compared to the relative fat mass of the group that had consumed maltodextrin but no galactose. The relative lean body mass was lower in the maltodextrin group compared to the group consuming galactose and maltodextrin; this was due to the fat mass increasing to a relatively higher extent than the lean body mass in the maltodextrin group. The observed effects on body composition development were similar in male and female mice.

Additionally the respiratory exchange rate (RER) was lower in the mice consuming the maltodextrin and galactose diet when compared to the mice consuming the maltodextrin diet without galactose. This is indicative for improved fat oxidation.

Additionally the energy expenditure (EE) and activity were lower in the mice consuming the maltodextrin and galactose diet when compared to the mice consuming the maltodextrin diet without galactose.

The results with mice consuming the diet comprising galactose and maltodextrin on body composition, RER, EE and activity were comparable to the results obtained with mice consuming the diet comprising free glucose and galactose, representing lactose. However, the presence of large amount of free glucose has additional disadvantages relating to e.g. regulatory requirements, taste imprinting and powder product technological properties.

Preferably the nutritional composition of the present invention is for use in improving body composition or body composition development, wherein the improvement is preferably a decreased relative amount of fat mass or decreased fat mass development and/or an increased lean body mass or lean body mass development.

Preferably the nutritional composition of the present invention is for use in maintaining a healthy body composition or body composition development, wherein the healthy body composition or body composition development is preferably preventing an increase in relative amount of fat mass or increase of relative fat mass development or preventing a decrease in relative lean body mass or relative body mass development.

Preferably the nutritional composition of the present composition is for preventing the development of an unhealthy body composition, in particular development of excessive relative fat mass.

In a third aspect the invention thus also relates to a nutritional composition comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose,
   for use in:
improving body composition or body composition development, preferably wherein the improvement is a decreased relative amount of fat mass or decreased fat mass development and/or an increased lean body mass or lean body mass development; or
maintaining a healthy body composition or body composition development, preferably wherein the healthy body composition or body composition development is preventing an increase in relative amount of fat mass or increase of relative fat mass development or preventing a decrease in relative lean body mass or relative body mass development; or
preventing the development of an unhealthy body composition, in particular development of excessive relative fat mass,
   in an infant or young child.

The improvement, maintenance and preventing as described above are as compared to an infant or young child consuming a nutritional composition wherein the digestible carbohydrate component is high in glucose or high in glucose polymers such as maltose, glucose syrup and maltodextrin, and low in free galactose and/or lactose.

The third aspect of the invention may be worded as a method for improving body composition or body composition development in an infant or a young child, wherein the improvement is preferably a decreased relative amount of fat mass and/or increased relative amount of lean body mass, wherein the method comprises a step of administering the nutritional composition according to the invention to the infant or young child. This aspect of the invention also relates to a method for maintaining a healthy body composition or body composition development in an infant or a young child, wherein the healthy body composition or body composition development is preferably preventing an increase in relative amount of fat mass or increase of relative fat mass development or preventing a decrease in relative lean body mass or relative body mass development, wherein the method comprises a step of administering the nutritional composition according to the invention to the infant or young child. The third aspect of the invention further relates to a method for preventing the development of an unhealthy body composition in an infant or a young child, in particular preventing the development of excessive relative fat mass, wherein the method comprises a step of administering the nutritional composition according to the invention to the infant or young child.

In this third aspect of the invention the invention also relates to the use of a mixture of free galactose and at least one digestible carbohydrate selected from the group consisting of maltodextrin and glucose syrup, wherein said maltodextrin and glucose syrup have a dextrose equivalent (DE) of 3 to 32, preferably 10 to 25, more preferably 17 to 22, for the manufacturing of a nutritional composition for use in:
improving body composition or body composition development, preferably wherein the improvement is a decreased relative amount of fat mass or decreased fat mass development and/or an increased lean body mass or lean body mass development; or
maintaining a healthy body composition or body composition development, preferably wherein the healthy body composition or body composition development is preventing an increase in relative amount of fat mass or increase of relative fat mass development or preventing a decrease in relative lean body mass or relative body mass development; or
preventing the development of an unhealthy body composition, in particular development of excessive relative fat mass,
   in an infant or young child,
   wherein the nutritional composition comprises a protein component, a lipid component, a digestible carbohydrate component and optionally a non-digestible oligosaccharide, wherein the digestible carbohydrate component comprises said mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component, and
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

The improvement, maintenance and preventing as described above are as compared to an infant or young child consuming a nutritional composition wherein the digestible carbohydrate component is high in glucose or high in glucose polymers such as maltose, glucose syrup and maltodextrin, and low in free galactose and/or lactose.

Preferably the nutritional composition of the present invention is for use in decreasing the respiratory exchange rate in an infant or young child. Preferably the nutritional composition of the present invention is for use in promoting (i.e. increasing) fat oxidation in an infant or young child.

In a fourth aspect, the invention relates to a nutritional composition according to the invention, for use in decreasing the respiratory exchange rate and/or increasing fat oxidation in an infant or young child. The invention thus also relates to a nutritional composition comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose,
   for use in:
decreasing the respiratory exchange rate; and/or
increasing fat oxidation.
   in an infant or young child.

The fourth aspect of the invention may also be worded as a method for decreasing the respiratory exchange rate and/or increasing fat oxidation in an infant or young child, the method comprising the administration of a nutritional composition to the infant or young child, wherein the nutritional composition comprises a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

This aspect may also be worded as the use of a mixture of free galactose and at least one digestible carbohydrate selected from the group consisting of maltodextrin and glucose syrup, wherein said maltodextrin and glucose syrup have a dextrose equivalent (DE) of 3 to 32, preferably 10 to 25, more preferably 17 to 22, for the manufacturing of a nutritional composition for use in:
decreasing the respiratory exchange rate, and/or
increasing fat oxidation,
   in an infant or young child,
   wherein the nutritional composition comprises a protein component, a lipid component, a digestible carbohydrate component and optionally a non-digestible oligosaccharide, wherein the digestible carbohydrate component comprises said mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component, and
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

In the fourth aspect of the invention the decreasing the respiratory exchange rate, and increasing fat oxidation are as compared to an infant or young child consuming a nutritional composition wherein the digestible carbohydrate component is high in glucose or high in glucose polymers such as maltose, glucose syrup and maltodextrin, and low in free galactose and/or lactose.

In a fifth aspect the nutritional composition of the present invention is for use in decreasing energy expenditure and/or preventing hyperactivity activity in an infant or young child. The invention thus also relates to a nutritional composition comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose,
   for use in:
decreasing the energy expenditure, and/or
preventing hyperactivity activity,
   in an infant or young child.

The fifth aspect of the invention may also be worded as a method for decreasing the energy expenditure, and/or preventing hyperactivity activity in an infant or young child, the method comprising the administration of a nutritional composition to the infant or young child, wherein the nutritional composition comprises a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32, preferably 10 to 25, more preferably 17 to 22,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component,
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

This aspect may also be worded as the use of a mixture of free galactose and at least one digestible carbohydrate selected from the group consisting of maltodextrin and glucose syrup, wherein said maltodextrin and glucose syrup have a dextrose equivalent (DE) of 3 to 32, preferably 10 to 25, more preferably 17 to 22, for the manufacturing of a nutritional composition for use in:
decreasing the energy expenditure, and/or
preventing hyperactivity activity,
   in an infant or young child,
   wherein the nutritional composition comprises a protein component, a lipid component, a digestible carbohydrate component and optionally a non-digestible oligosaccharide, wherein the digestible carbohydrate component comprises said mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component, and
the amount of free glucose is at most 10 wt % based on total weight of the digestible carbohydrate component,
and the amount of free glucose is lower than the amount of free galactose, both based on total weight of the digestible carbohydrate component, preferably the amount of free glucose is at most 80 wt % based on the total weight of free galactose.

In the fifth aspect of the invention the decreasing the energy expenditure, and the preventing hyperactivity activity are as compared to an infant or young child consuming a nutritional composition wherein the digestible carbohydrate component is high in glucose or high in glucose polymers such as maltose, glucose syrup and maltodextrin, and low in free galactose and/or lactose.

The preventing of developing an increased relative fat mass, increasing relative lean body mass and/or promoting of fat oxidation is highly beneficial as this is linked to health effects such as preventing or reducing the risk of the developing overweight or obesity, insulin resistance and diabetes type 2.

### EXAMPLES

### Example 1: a Diet with Galactose and Maltodextrin Improves Body Composition and Body Composition Development in Early Life in Male and Female Mice when Compared to a Diet with Maltodextrin

Diets: Galactose was obtained from Nutriscience Innovations USA. This galactose is obtained from acacia gum. Maltodextrin was obtained from Roquette and had DE of 19.

The diets tested contained (as en %):
Control Diet 1: 38.4 en % maltodextrin, 7.9 en % glucose
Control Diet 2: 14.9 en % maltodextrin, 15.7 en % glucose, 15.7 en % galactose
Test diet 3: 30.6 en % maltodextrin, 15.7 en % galactose.

Each diet contained the same amounts in energy percentage of protein (20 en %), lipids (15 en %) and carbohydrates (65 en %) coming from the maltodextrin, glucose and galactose and the remainder coming from wheat starch (14.9 en %).

The basis of the diet was AlN-93G.

Control Diet 2 with glucose+galactose 1:1 was chosen to represent a diet with lactose. However, as mice cannot digest lactose it is present in the diet as predigested lactose. This diet is the positive control. The Control maltodextrin diet 1 contains some glucose as hardness would otherwise intervene with food intake. Intervention diets were given as dough balls (50 gram diet mixed with 10 ml water into dough balls), which were placed in glass cup on the floor of the cage (dough balls weights: 5-7 grams) and were provided twice a week.

Male and female C57BL/6JRccHsd mice were obtained from Harlan (Harlan Laboratories BV). The mice were given a semisynthetic breeding diet (16 en % fat, 20 en % protein, 64 en % carbohydrates) and time-mated. Nests were standardized to 6 pups per nest 0-2 d after birth, with 2-4 female pups per nest. After weaning at 3 week of age, the pups were stratified by sex and body weight (BW), maximizing the number of nests contributing to the dietary groups, and given the post weaning diets 1, 2 or 3 until postnatal day (PN) 42. Food intake was measured weekly. At PN 42 body weight (BW) and body composition (BC) was determined using an EchoMRI 100 V (EchoMedical Systems).

Food and water were available ad libitum. During all procedures, the mice were kept in a controlled environment (23° C.±1° C. 12 h:12 h light/dark cycle).

At PN 40-42, female mice (n=8) were introduced in their home cages into the indirect calorimetry system, with ad libitum access to food and water. The amount of bedding was slightly reduced and nest material was reduced per cage in order to enable activity measurements (these are based on interruption of infrared light beams by the mouse, but beams can also be blocked by excessive bedding and foreign objects in the cage). Acclimation to this new environment was allowed for approximately 1 day till start of next light phase. The following 24-h period was used for basal measurements of metabolism. Before and after entering the indirect calorimetry (InCa) system, body weight and body composition was determined in order to scientifically correct energy expenditure for lean mass, if needed (Tschöp et al., 2012, Nature Methods 29, 57-63). The general procedure for indirect calorimetry measurements has been described previously (Hoevenaars et al., Exp. Physiol. 2013, 98(5), 1053-1062), with minor adjustments. The energy expenditure (EE), respiratory exchange ratio (RER), locomotor activity were measured in a PhenoMaster indirect calorimetry system (TSE Systems GmbH, Bad Homburg, Germany),

Statistics: For all normally distributed data, One-Way ANOVA, followed by post hoc test when all 3 groups were compared, unless also time is taken along, then 2-way ANOVA was used. P<0.05 was considered significant; * p<0.05, ** p<0.01, *** p<0.001, ****p<0.0001.

### Results:

Results are shown in Table 1. At day 42 the average body weight of female and male mice of group 1 was significantly higher than that of group 2 or 3. Body mass, lean body mass and fat mass were all increased in group 1 compared to group 2 and 3. The relative fat mass of mice in group 1 was higher than that of group 2 and 3. The relative lean body mass (%) of mice in group 1 was significantly lower than that of group 2 and 3, due to the fat mass increasing to a relatively higher extent than the lean body mass in group 1. No significant difference was observed between group 2 and 3. This is indicative for an improved body composition and body composition development with a composition according to the invention comprising galactose and maltodextrin. This is when compared to the group of mice that consumed a diet with digestible carbohydrates high in maltodextrin without free galactose.

The respiratory exchange rate (RER) was significantly higher in group 1 when compared to group 2 and 3, both during the dark (active) and during light phase (see Table 2). The RER is an indication for the respiratory quotient (RQ), an indicator of which fuel (e.g. carbohydrate or lipid) is being metabolized to supply the body with energy. An RER near 0.7 indicates that fat is the predominant fuel source, a value of 1.0 is indicative of carbohydrate being the predominant fuel source, and a value between 0.7 and 1.0 suggests a mix of both fat and carbohydrate. These results are therefore indicative of lower carbohydrate oxidation and increased fat oxidation in group 2 and 3 when compared to group 1. The differences in RER may contribute to the observed difference in body composition development.

Energy expenditure (EE) was significantly higher in group 1 compared to group 2 and 3 both during the dark (active) and light phase. No significant difference was observed between group 2 and 3.

Activity was higher in the mice consuming diet 1 compared to the other groups, and this was caused by an activity during the dark phase. These results could be indicative for hyper-reactivity to the elements in the environment. This is less desirable as this could be possibly due to declining concentration ability, such as a sugar rush. It is surprising that group 1 is more active, has a higher energy expenditure based on lean mass (LM) and at the same time having higher body weight, fat mass and relative fat mass. The increased level of activity is not sufficient to compensate for significantly higher level of quick available energy from the diet.

No difference in food intake was observed between the three groups.

The results for RER are shown in Table 2 and the results for EE and activity are shown in Table 3. These values were only determined for female mice. However it is expected that similar results will be obtained for male mice.

TABLE 1
Body weight, fat mass and lean mass of mice consuming diet 1, 2 or 3 at day 42.

| | Average (+s.e.) | | | | | |
|---|---|---|---|---|---|---|
| | female | | | male | | |
| Diet | 1 | 2 | 3 | 1 | 2 | 3 |
| Body weight | 14.1* | 11.1 | 10.9 | 15.98* | 12.9 | 11.9 |
| (g) | (0.2854) | (0.2945) | (0.4311) | (0.2699) | (0.4447) | (0.4138) |
| Fat mass (g) | 1.56* | 0.54 | 0.65 | 0.89* | 0.43 | 0.52 |
| | (0.07725) | (0.05218) | (0.06789) | (0.08552) | (0.06620) | (0.03568) |
| Relative Fat | 11.9* | 5.2 | 6.3 | 6.0\hat{ } | 3.5 | 4.7 |
| mass(%) | (0.4667) | (0.4553) | (0.4605) | (0.5412) | (0.4750) | (0.3681) |
| Lean body | 11.6* | 9.7 | 9.5 | 14.00* | 11.46 | 10.59 |
| mass (g) | (0.2056) | (0.2305) | (0.3462) | (0.2272) | (0.3623) | (0.3958) |
| Relative | 88* | 95 | 94 | 94* | 97 | 95 |
| Lean Body | (0.466652) | (0.4549126) | (0.4607389) | (0.5413208) | (0.4750038) | (0.3678263) |
| mass (%) | | | | | | |

*P < 0.05 when compared to diet 2 or 3.
\hat{ }P < 0.05 when compared to diet 2.

TABLE 2
RER data in female mice consuming diet 1, 2 or 3, at day 42.

| | Average (+s.e.) | | |
|---|---|---|---|
| | female | | |
| | Diet | | |
| | 1 | 2 | 3 |
| RER total (VCO2/CVO2) | 0.92* | 0.88 | 0.87 |
| | (0.004646) | (0.006044) | (0.007572) |
| RER light (VCO2/CVO2) | 0.88# | 0.87 | 0.85 |
| | (0.01038) | (0.009204) | (0.008544) |
| RER dark (VCO2/CVO2) | 0.96* | 0.90 | 0.89 |
| | (0.004559) | (0.007327) | (0.01020) |

*p < 0.05 when compared to diet 2 or 3
#p < 0.05 when compared to diet 3

TABLE 3
EE and activity data in female mice
consuming diet 1, 2 or 3, at day 42.

| | Average (+s.e.) | | |
|---|---|---|---|
| | female | | |
| | Diet | | |
| | 1 | 2 | 3 |
| EE corrected for LM total | 0.0275* | 0.0188 | 0.0215 |
| (kcal/h) | (0.0007745) | (0.001022) | (0.0006707) |
| EE corrected for LM light | 0.0247* | 0.0208 | 0.0208 |
| (kcal/h) | (0.0007506) | (0.0006634) | (0.0006634) |
| EE corrected for LM dark | 0.0303* | 0.0189 | 0.0223 |
| (kcal/h) | (0.0008680) | (0.001338) | (0.0009411) |
| Activity total (counts) | 227104 | 131969# | 151848 |
| | (21091) | (20261) | (25592) |
| Activity light (counts) | 43723 | 51215 | 49514 |
| | (6903) | (8684) | (10443) |
| Activity dark (counts) | 183380 | 80754 | 102333 |
| | (15914)* | (13251) | (16571) |

*p < 0.05 when compared to diet 2 or 3
#p < 0.05 when compared to diet 3

### Example 2: a Product for Infants that are Suffering from Cow's Milk Protein Allergy Containing Extensively Hydrolysed Whey Protein as Protein Component in Powder Form

The powder can be reconstituted with water to form a ready to drink formula with an energy density of 67 kcal/100 ml. The formula further comprises minerals, trace elements, vitamins according to international directives for infant formula.

| Nutrient | Unit | Recipe 1 | Recipe 2 |
|---|---|---|---|
| Digestible Carbohydrates | g | 55.43 | 57.85 |
| Lactose | | 24.00 | 22.97 |
| Polysaccharides (maltodextrin) | g | 20.67 | 17.08 |
| Free Galactose | g | 7.08 | 14.08 |
| Free Glucose (dextrose) | g | 1.82 | 1.71 |
| Maltose | g | 1.20 | 0.99 |
| Other | g | 0.67 | 1.03 |
| Protein (mainly hydrolysed whey | g | 10.94 | 10.46 |
| protein) | | | |
| Lipids | g | 23.46 | 22.43 |
| Total energy | kcal | 475.61 | 472.74 |

### Example 3: An Amino Acid Based Lactose Free Formula for Infants and Young Children that are Lactose Intolerant or have Severe or Multiple Food Allergies

The formula is in powder form and can be reconstituted to that ready to drink formula containing about 68 kcal/100 ml. About 14.4 g powder is needed to reconstitute with 90 ml water to form 100 ml ready to drink formula. Per 100 g dry weight the formula contains:

| | Unit (per 100 g | | |
|---|---|---|---|
| Nutrient | dry weight) | Recipe 1 | Recipe 2 |
| Protein equivalent (present in | g | 15.067 | 15.002 |
| the form of free amino acids) | | | |
| Digestible Carbohydrates | g | 50.67 | 50.452 |
| Free Glucose | g | 0.517488 | 0.716063 |
| (dextrose) | | | |
| Fructose | g | 0.167256 | 0.166536 |
| Free Galactose | g | 20.26 | 10.13 |
| Maltose | g | 1.69 | 2.386 |
| Sucrose | g | 0.1 | 0.1 |
| Polysaccharides | g | 26.836 | 35.857 |
| Starch | g | 4.976 | 4.954 |
| Maltodextrin / | g | 19.522 | 27.571 |
| Glucose syrup | | | |
| Organic acids | g | 0.94 | 0.94 |
| Short chain Fructo- | g | 4.5 | 4.5 |
| oligosaccharides:long chain | | | |
| fructooligosaccharides 9:1 | | | |
| wt/wt | | | |
| Lipids | g | 24.062 | 23.959 |

The composition further contains minerals, trace elements, vitamins according to international directives for infant or follow on formulas, to add up to 100 g.

### Example 4: Young Child Formula that does not Contain Animal Derived Products

The composition of the young child formula is shown in the Table below. The amounts are given per 100 ml ready to drink formula. The composition contains 71 kcal per 100 ml ready to drink formula. The composition further comprises micronutrients, such as minerals and vitamins as known in the art.

| | Unit (per 100 ml | | |
|---|---|---|---|
| | ready to drink | Reci- | Reci- |
| Nutrient | formula) | pe 1 | pe 2 |
| Digestible carbohydrates | g | 7.4 | 7.4 |
| Free Galactose | g | 2.84 | 1.42 |
| Maltose | g | 0.28 | 0.28 |
| Maltodextrin | g | 4.26 | 5.68 |
| Lipids (vegetable oils, lecithin) | g | 3.5 | 3.5 |
| Protein (from soy) | g | 2.5 | 2.5 |

1. Nutritional composition for infants and young children comprising a protein component, a lipid component, a digestible carbohydrate component and optionally a non-digestible oligosaccharide, wherein the digestible carbohydrate component comprises a mixture of free galactose and at least one digestible carbohydrate selected from the group consisting of maltodextrin and glucose syrup, and wherein:
the mixture of free galactose and at least one digestible carbohydrate selected from the group consisting of maltodextrin and glucose syrup is present in an amount of at least 50 wt % based on the total weight of the digestible carbohydrate component,
said maltodextrin and glucose syrup have a dextrose equivalent (DE) of 3 to 32,
the amount of free galactose is from 10 to 60 wt % based on total weight of the digestible carbohydrate component,
the amount of the at least one digestible carbohydrate selected from the group consisting of maltodextrin and glucose syrup is from 40 to 90 wt % based on total weight of the digestible carbohydrate component, and
the amount of free glucose is at most 10 wt % based on total weight of the digestible carbohydrate component,
and the amount of free glucose is lower than the amount of free galactose, both based on total weight of the digestible carbohydrate component.

2. Nutritional composition according to claim 1, wherein the digestible carbohydrate component comprises a mixture of free galactose and maltodextrin.

3. Nutritional composition according to claim 1, wherein the wt/wt ratio of galactose to the at least one digestible carbohydrate selected from the group consisting of maltodextrin and glucose syrup is from 1:9 to 1.5:1.

4. Nutritional composition according to claim 1, wherein the amount of free galactose and the at least one digestible carbohydrate selected from the group consisting of maltodextrin and glucose syrup is 3 to 20 g per 100 kcal, and/or 2 to 15 g per 100 ml ready to drink formula, and/or 15 wt % to 85 wt % based on dry weight of the nutritional composition.

5. Nutritional composition according to claim 1, wherein the nutritional composition is an infant formula, a follow on formula or a young child formula.

6. Nutritional composition according to claim 1, wherein the galactose is not from animal origin.

7. Nutritional composition according to claim 1, wherein the protein component is at least one selected from the group consisting of free amino acids, hydrolyzed protein and plant protein, preferably free amino acids and plant protein.

8. Nutritional composition according to claim 1, wherein the composition does not contain animal-derived ingredients.

9. Nutritional composition according to claim 1, wherein the composition comprises less than 45 wt % lactose based on total weight of the digestible carbohydrate component.

10. Nutritional composition according to claim 1, wherein the amount of lactose is below 0.1 wt %, based on dry weight of the nutritional composition.

11. Method for providing nutrition to an infant or a young child, the method comprising administering the composition according to claim to the infant or young child.

12-15. (canceled)

16. The method according to claim 11, wherein the n infant or young child is lactose intolerant.

17. The method according to claim 11, wherein the infant or young child is at risk of developing allergy and/or suffers from allergy.

18. The method according to claim 11, wherein the method is for improving body composition or body composition development in an infant or a young child.

19. The method according to claim 18, wherein the improvement is a decreased relative amount of fat mass and/or an increased relative amount of lean body mass.

20. The method according to claim 11, wherein the method is for decreasing the respiratory exchange rate and/or increasing fat oxidation in an infant or young child.

21. The nutritional composition according to claim 1, wherein the maltodextrin and glucose syrup have a dextrose equivalent (DE) of 10 to 25.

22. The nutritional composition according to claim 1, the amount of free glucose is at most 80 wt % based on the total weight of free galactose.

23. The nutrition composition according to claim 3, wherein the wt/wt ratio of galactose to the at least one digestible carbohydrate selected from the group consisting of maltodextrin and glucose syrup is from 1:5 to 1.5:1.

24. The nutritional composition according claim 6, wherein the galactose is from plant or microbial origin.
